(19) United States
(12) Patent Application Publication
(10) Pub. No.: US 2010/0082330 A1
(43) Pub. Date: Apr. 1, 2010

(54) MULTI-LINGUAL MAPS

(75) Inventors: Ankur Ankur, Sydney (AU); Xiang Wei Zhuo, Sydney (AU)

Correspondence Address: Weaver Austin Villeneuve & Sampson - Yahoo!, P.O. BOX 70250, OAKLAND, CA, 94612-0250, US

(73) Assignee: Yahoo! Inc.

(21) Appl. No.: 12/240,468

(22) Filed: Sep. 29, 2008

(51) Int. Cl. G06F 17/20; G06F 17/30

(52) U.S. Cl. 704/8; 704/E15.003

(57) ABSTRACT

Disclosed are methods and apparatus for supporting multi-lingual maps are disclosed. In one embodiment, a query indicating that a map is requested is received. A language in which the map is to be presented is determined. A set of map data for rendering the map is obtained, wherein the set of map data includes image data and text data. A translation of the text data in the set of map data is obtained such that the text data is translated to the language in which the map is to be presented. The image data and the translated text data are then provided.

### SUMMARY OF THE INVENTION

Disclosed are methods and apparatus for supporting multi-lingual maps. This may be accomplished, in part, by maintaining image data separate from text data. The text data may then be translated, as appropriate.

In one embodiment, a query indicating that a map is requested is received. A language in which the map is to be presented is determined. A set of map data for rendering the map is obtained, wherein the set of map data includes image data and text data. A translation of the text data in the set of map data is obtained such that the text data is translated to the language in which the map is to be presented. The image data and the translated text data are then provided.

In accordance with another embodiment, the set of map data includes image data and text data associated with one or more countries, wherein the text data associated with each of the one or more countries is in a language of the corresponding country. For example, the text associated with a map of the United States may be in English, while the text associated with a map of France may be in French.

In accordance with yet another embodiment, the primary language spoken in one region of a country may be different than the primary language spoken in another region of the same country. Thus, the set of map data may include image data and text data associated with one or more geographical regions, where the text data associated with each of the regions is in a language of the corresponding region.

In accordance with yet another embodiment, a query indicating that a map is requested is received. A language in which the map is to be presented is ascertained, wherein the language in which the map is to be presented is a first language. A set of map data for rendering the map is obtained, wherein the set of map data includes image data and text data, wherein the text data is in a second language. Depending upon the query, the set of map data may be obtained for a particular geographical segment or region. It is determined whether the first language is different from the second language. The text data is translated from the second language to the first language according to whether the first language is different from the second language

In another embodiment, the invention pertains to a device comprising a processor, memory, and a display. The processor and memory are configured to perform one or more of the above described method operations. In another embodiment, the invention pertains to a computer readable storage medium having computer program instructions stored thereon that are arranged to perform one or more of the above described method operations.

In accordance with one aspect, image data may include shapes, as well as attributes associated with the shapes. These attributes may include color, shading, and other effects. The shapes displayed on a map may represent physical regions of land or water. As a result, various shapes may identify bodies of water such as oceans or rivers. Moreover, various shapes may identify roads, mountains, or other landmarks on the map. Similarly, the shapes may delineate boundaries of countries, states, or cities. These examples are merely illustrative, and therefore the shapes may be displayed on a map for other purposes as well. Moreover, image data may include other information not described herein.

In accordance with another aspect, text data may include information enabling text (e.g., characters) to be displayed on a map. For example, the text may be displayed as a label or in association with a symbol, icon, legend, etc. The characters may include one or more letters, punctuation marks, or other characters available on a standard computer.

In accordance with yet another aspect, the text data may also have text display information associated therewith. Text display information may indicate a particular font in which the text is to be displayed, as well as other formatting information associated with the text. Formatting information may indicate whether the text is to be bolded, underlined, italicized, capitalized, etc. The text display information may further indicate a location on the map at which the text is to be displayed. The location may be a specific location (e.g., coordinates) on the map, or a location with respect to one or more shapes on the map.

These and other features and advantages of the present invention will be presented in more detail in the following specification of the invention and the accompanying figures which illustrate by way of example the principles of the invention.

### BRIEF DESCRIPTION OF THE DRAWINGS

FIG. 1 is a diagram illustrating an example network segment in which various embodiments of the invention may be implemented.

FIG. 2 is a diagram illustrating an example graphical user interface for viewing a map.

FIG. 3 is a process flow diagram illustrating an example method of displaying a map in accordance with various embodiments of the invention.

FIG. 4 is a process flow diagram illustrating an example method of determining a language in which a map is to be provided.

FIG. 5 is a simplified diagram of a network environment in which specific embodiments of the present invention may be implemented.

FIG. 6 illustrates an example computer system in which specific embodiments of the present invention may be implemented.

### DETAILED DESCRIPTION OF THE SPECIFIC EMBODIMENTS

Reference will now be made in detail to specific embodiments of the invention. Examples of these embodiments are illustrated in the accompanying drawings. While the invention will be described in conjunction with these specific embodiments, it will be understood that it is not intended to limit the invention to these embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention.

The disclosed embodiments enable a map to be translated and provided to a user in response to a query. Specifically, map data including text data and image data may be stored. When appropriate, the text data (or portion thereof) may be translated. The image data and corresponding translated text data may then be provided and viewed as a single map. In this manner, a map may be provided in a variety of languages.

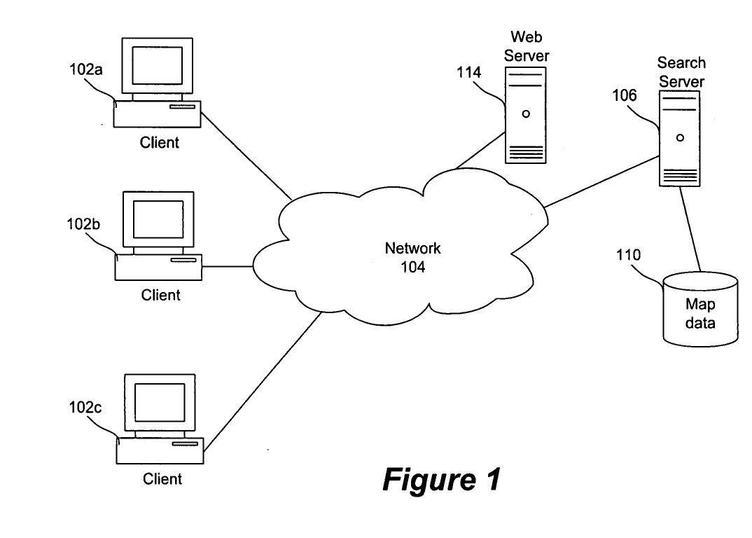

FIG. 1 illustrates an example network segment in which various embodiments of the invention may be implemented. As shown, a plurality of clients 102a, 102b, 102c may access a map application, for example, on map server 106 via network 104 and/or access a web service, for example, on web server 114. The network may take any suitable form, such as a wide area network or Internet and/or one or more local area networks (LAN's). The network 104 may include any suitable number and type of devices, e.g., routers and switches, for forwarding map or web object requests from each client to the map or web application, and map or web results back to the requesting clients.

The invention may also be practiced in a wide variety of network environments (represented by network 104) including, for example, TCP/IP-based networks, telecommunications networks, wireless networks, etc. In addition, the computer program instructions with which embodiments of the invention are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

A map application generally allows a user (human or automated entity) to enter a map search query to search for a location on a map. A map location including one or more terms may be entered by a user in any manner. For example, the map application may present a web page having any input feature to the client (e.g., on the client's device) so the client can enter a map search query (e.g., location) including one or more term(s). In a specific implementation, the map application presents an input box into which a user may type a map query including any number of terms. Embodiments of the present invention may be employed with respect to any search application. The map application may be implemented on any number of servers although only a single map server 106 is illustrated for clarity.

When maps are accessed, text and images are usually integrated together, making it difficult to cater to the language needs of users. In accordance with various embodiments, the map server 106 (or servers) may have access to map data 110 including text data and image data, which may be stored separately. The map data 110 may be obtained from a map data provider such as Navdeq. Each time a user performs a map query including one or more map terms, information regarding such query may be obtained from the map data 110. Specifically, text data and corresponding image data may be obtained from the map data 110. Typically, the map data 110 is provided by sources of map data in a single language. As a result, the text data that has been obtained may not be in the language spoken by the user requesting the map.

In order to ascertain the language spoken by the user and therefore the language in which the text of the map is to be provided, information associated with the user may be obtained, if available. For instance, the user's native language may be obtained from a user profile. Of course, if the user does not have a profile, it may be possible to simply use the language of the country of the web site being accessed. For example, if the user is accessing a French web site such as Yahoo.fr, it may be assumed that the user speaks French. As yet another example, it is also possible to analyze the user's input to determine which language the user is speaking. If the language in which the text data has been stored is different from the language of the user, the map application may translate the text data that has been obtained. The translated text data and corresponding image data may then be provided to one of the clients 102a, 102b, 102c in response to a map query. The client may then display the image data and translated text data. Specifically, the image data may be displayed as a separate layer from the translated text data. In this manner, a map may be generated in a language that is suitable for the user. In addition to determining the user's language, information useful for further customizing the map may be obtained. This information may be specific to the region or country of the user that indicates preferences of individuals living in that region or country. Moreover, this information may also be specific to the individual, indicating that individual's preferences as to what they would like to see in their user interface.

In accordance with one embodiment, where the system is described herein as determining the user's language, the user's “locale” may be determined. In computing, the term “locale” often refers to a set of parameters that defines the user's language, country and any user preferences that the user wants to see in their user interface. A locale identifier may include a language identifier and a region identifier.

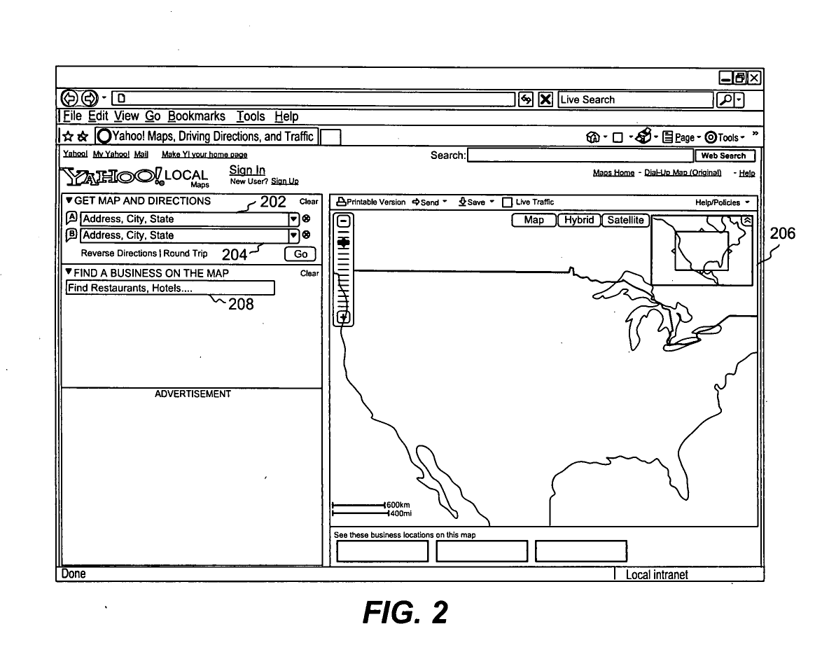

FIG. 2 is a diagram illustrating an example graphical user interface for viewing a map. A user may access a map and/or directions associated with the map. Specifically, a user may simply enter a location (e.g., landmark) or address (e.g., city, state, country, and/or specific mailing address) in order to view a map of an area including this location or address.

In this example, a user may obtain directions by entering a source address in a corresponding input box 202 and a destination address in a corresponding input box 204. Each address may include a city, state, address, and/or location (e.g., location name). In response to such a user query, a map application may obtain map data from memory, where the map data covers a region including both the source address and destination address. In addition, the map application may generate directions from the source address to the destination address. Text data that is translated may include labels on the map, as well as other pertinent data on the map. Moreover, directions may be provided in the desired language or translated to the desired language, as appropriate. A map 206 that is generated may therefore include image data associated with the region, as well as any corresponding translated text. A line or other suitable indicator may also be provided on the map to indicate the desired route.

In one embodiment, a user may find a business on the map by entering a name of the business in input box 208. A map application may obtain map data from memory, where the map data covers a region that includes the business. The map that is displayed may also identify the business via a symbol, text, and/or other indicator. In order to generate the map, image data and any translated text (and/or text that has not been translated) may be displayed.

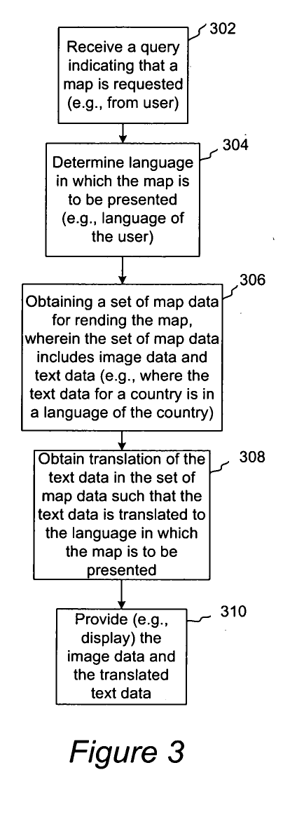

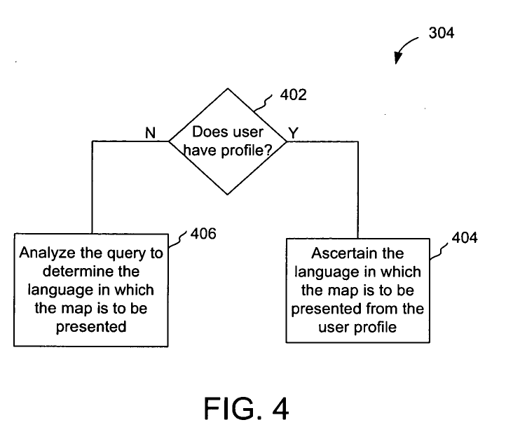

FIG. 3 is a process flow diagram illustrating an example method of displaying a map in accordance with various embodiments of the invention. A query indicating that a map is requested may be obtained at 302. A language in which the map is to be presented may be determined at 304. The language may be a language of the user, as will be described in further detail below with reference to FIG. 4.

Map data that is stored in memory may include map data associated with one or more countries. The text data associated with each of the countries may be stored in a language of the corresponding country. For example, the text data associated with a map of France may be stored in French, while the text data associated with a map of Israel may be stored in Hebrew. As a result, people who cannot speak Hebrew may be unable to read the Hebrew characters on the map.

A set of the map data for rendering the map may be obtained at 306, where the set of map data includes image data and text data. The image data may include shapes delineating regions of the map, colors associated with various delineated regions, icons, etc. The text data may have associated text display information (e.g., font, bold, underline, etc.). The text data may be in a first language, while the language in which the map (or segment of the map) is to be presented may be in a second language.

A translation of the text data (or portion thereof) in the set of map data may be obtained at 308 such that the text data is translated to the language in which the map is to be presented. Specifically, a map application may determine whether the first language (e.g., language associated with a country for which image data is to be presented) is different from the second language. The text data (or portion thereof) may be translated according to whether the first language is different from the second language. In other words, if the language in which the text data is stored is the same as the desired language, the text data need not be translated. If the language in which the text data is stored is different from the desired language, the text data may be translated. The image data and the translated text data (and/or non-translated text data) may be provided (e.g., displayed) at 310.

Translating text data in the set of map data may be accomplished via a translation mapping file that simply maps terms from one language to another language. The text data that is translated may be associated with labels, names, symbols, etc. Specifically, one or more translation files may include a mapping between text in a language in which the text data has been stored and text in the desired language. Alternatively, the text data may be dynamically translated using a translation program. A translation program may be accessed via a variety of web sites, such as Babel Fish. Since much of the text that is translated may simply include locations on a map, the translation process may simply include translating from one character set (e.g., English) to another character set (e.g., Chinese characters). For instance, the name “San Francisco” may be translated to Chinese characters.

It is important to note that the set of map data may include text data that is to be translated, as well as text data that is not to be translated. Thus, the text data that is not to be translated may be provided without translation. The text data that is not translated be associated with labels, names, symbols, etc.

FIG. 4 is a process flow diagram illustrating an example method of determining a language in which a map (or portion thereof) is to be provided as described above with reference to 304 of FIG. 3. The language in which the map is to be presented may be determined by ascertaining a language of the user. This may be accomplished by obtaining information associated with the user from which the query was received.

The information associated with the user may include a user profile. For instance, the user may have logged in using a username and password to an account such as a Yahoo! account, enabling the user profile to be obtained. In accordance with one embodiment, it may be determined whether the user has a user profile at 402. If the user does have a user profile (e.g., the user has logged in), the language in which the map is to be presented may be ascertained from the user profile at 404. The language may be identified implicitly or explicitly within the user profile. For instance, the user may identify his or her language as French in the user profile. As another example, the user may provide his or her residence address as an address in France. Since the user lives in France, it may be deduced that the user speaks French.

Alternatively, if the user does not have a user profile (e.g., the user has not logged in), the language in which the map is to be presented may be ascertained by analyzing the query (i.e., input received from the user) at 406. For instance, character input received from a keyboard may be analyzed to determine which language the user would prefer. For instance, punctuation may be analyzed to ascertain the desired language. As another example, various keyboards and therefore different types of characters may be used in different parts of the world. For instance, Chinese characters may imply that the user speaks Chinese, while Hebrew characters may imply that the user speaks Hebrew.

Other mechanisms for determining a language in which the map is presented may include analyzing historical usage associated with the user's IP address (e.g., via a cookie associated with the user) or identifying a web site via which the query was received. For instance, if the user has accessed Yahoo.fr, it may be assumed that the user speaks French.

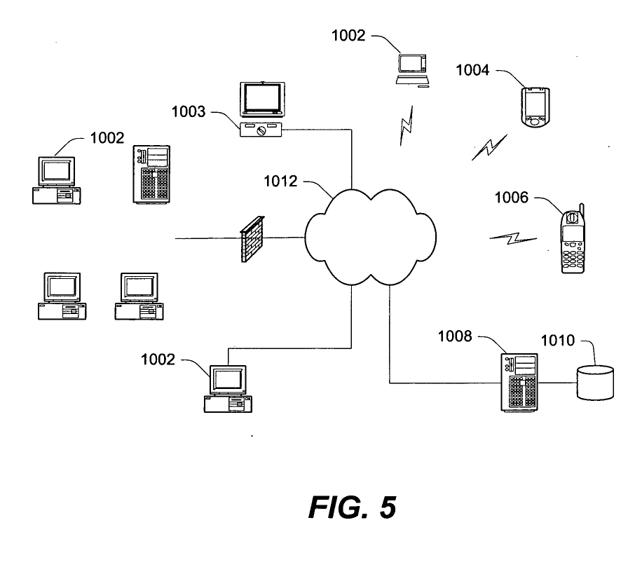

Embodiments of the present invention may be employed to process a map query in order to provide a requested map in a variety of languages. For example, as illustrated in FIG. 5, implementations are contemplated in which users interact with a diverse network environment via any type of computer (e.g., desktop, laptop, tablet, etc.) 1002, media computing platforms 1003 (e.g., cable and satellite set top boxes and digital video recorders), handheld computing devices (e.g., PDAs) 1004, cell phones 1006, or any other type of computing or communication platform.

And according to various embodiments, input that is processed in accordance with the invention may be obtained using a wide variety of techniques. For example, a search query may be obtained from a user's interaction with a local application, web site or web-based application or service and may be accomplished using any of a variety of well known mechanisms for obtaining information from a user. However, it should be understood that such methods of obtaining input from a user are merely examples and that a search query may be obtained in many other ways.

Once map data associated with one or more countries has been obtained, the map data may be processed according to the invention in some centralized manner. This is represented in FIG. 5 by server 1008 and data store 1010 which, as will be understood, may correspond to multiple distributed devices and data stores. The invention may also be practiced in a wide variety of network environments (represented by network 1012) including, for example, TCP/IP-based networks, telecommunications networks, wireless networks, etc. In addition, the computer program instructions with which embodiments of the invention are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

The disclosed techniques of the present invention may be implemented in any suitable combination of software and/or hardware system, such as a web-based server or desktop computer system. The map generating apparatus of this invention may be specially constructed for the required purposes, or it may be a general-purpose computer selectively activated or reconfigured by a computer program and/or data structure stored in the computer. The processes presented herein are not inherently related to any particular computer or other apparatus. In particular, various general-purpose machines may be used with programs written in accordance with the teachings herein, or it may be more convenient to construct a more specialized apparatus to perform the required method steps.

Regardless of the system's configuration, it may employ one or more memories or memory modules configured to store data, program instructions for the general-purpose processing operations and/or the inventive techniques described herein. The program instructions may control the operation of an operating system and/or one or more applications, for example. The memory or memories may also be configured to store map data including text and/or images, information associated with users, translations for map text in various languages, etc.

Because such information and program instructions may be employed to implement the systems/methods described herein, the present invention relates to machine readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

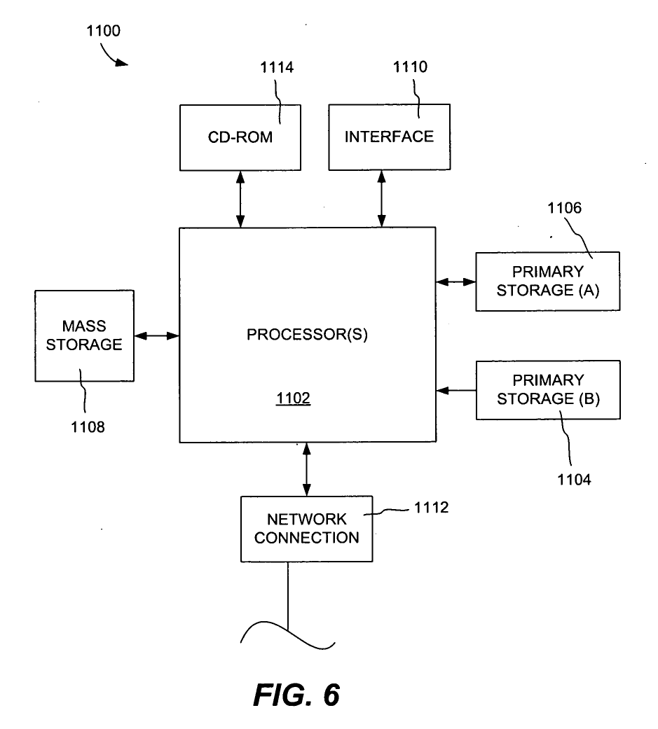

FIG. 6 illustrates a typical computer system that, when appropriately configured or designed, can serve as a system of this invention. The computer system 1100 includes any number of processors 1102 (also referred to as central processing units, or CPUs) that are coupled to storage devices including primary storage 1106 (typically a random access memory, or RAM), primary storage 1104 (typically a read only memory, or ROM). CPU 1102 may be of various types including microcontrollers and microprocessors such as programmable devices (e.g., CPLDs and FPGAs) and unprogrammable devices such as gate array ASICs or general purpose microprocessors. As is well known in the art, primary storage 1104 acts to transfer data and instructions uni-directionally to the CPU and primary storage 1106 is used typically to transfer data and instructions in a bi-directional manner. Both of these primary storage devices may include any suitable computer-readable media such as those described above. A mass storage device 1108 is also coupled bi-directionally to CPU 1102 and provides additional data storage capacity and may include any of the computer-readable media described above. Mass storage device 1108 may be used to store programs, data and the like and is typically a secondary storage medium such as a hard disk. It will be appreciated that the information retained within the mass storage device 1108, may, in appropriate cases, be incorporated in standard fashion as part of primary storage 1106 as virtual memory. A specific mass storage device such as a CD-ROM 1114 may also pass data uni-directionally to the CPU.

CPU 1102 may also be coupled to an interface 1110 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 1102 optionally may be coupled to an external device such as a database or a computer or telecommunications network using an external connection as shown generally at 1112. With such a connection, it is contemplated that the CPU might receive information from the network, or might output information to the network in the course of performing the method steps described herein.

Although the foregoing invention has been described in some detail for purposes of clarity of understanding, it will be apparent that certain changes and modifications may be practiced within the scope of the appended claims. For example, although the disclosed embodiments refer to maps, these embodiments may also be applied to other types of search queries and associated search results. Specifically, search results obtained in one language may be provided to a user in the user's language (e.g., identified via an input query term). As yet another example, the embodiments described herein refer to the determination of the user's language. However, in these instances, it is also possible to determine the user's locale. Therefore, the present embodiments are to be considered as illustrative and not restrictive and the invention is not to be limited to the details given herein, but may be modified within the scope and equivalents of the appended claims.

What is claimed is:

1. A method, comprising:
receiving a query, the query indicating that a map is requested;
determining a language in which the map is to be presented;
obtaining a set of map data for rendering the map, wherein the set of map data includes image data and text data;
obtaining a translation of the text data in the set of map data such that the text data is translated to the language in which the map is to be presented; and
providing the image data and the translated text data.

2. The method as recited in claim 1, wherein providing the image data and the translated text data comprises:
displaying the image data and the translated text data.

3. The method as recited in claim 1, wherein the text data is in a first language and wherein the language in which the map is to be presented is a second language.

4. The method as recited in claim 1, wherein the query is received from a user and wherein determining a language in which the map is to be presented comprises:
ascertaining a language of the user.

5. The method as recited in claim 1, wherein the map data includes map data associated with one or more countries, wherein the text data associated with each of the one or more countries is in a language of the corresponding one of the one or more countries.

6. The method as recited in claim 1, wherein determining a language in which the map is to be presented comprises:
obtaining information associated with a user from which the query was received.

7. The method as recited in claim 6, wherein the information associated with the user comprises a cookie.

8. The method as recited in claim 6, wherein the information associated with the user includes a user profile.

9. The method as recited in claim 1, wherein the query is received from a user, wherein determining a language in which the map is to be presented comprises:
identifying the language in which the map is to be presented from input received from the user.

10. The method as recited in claim 1, wherein the query is received from a user, wherein determining a language in which the map is to be presented comprises:
analyzing character input received from a keyboard.

11. The method as recited in claim 1, wherein determining a language in which the map is to be presented comprises:
identifying a web site via which the query was received.

12. The method as recited in claim 1, wherein obtaining a translation of the text data in the set of map data comprises:
obtaining the translation of the text data from a translation file.

13. The method as recited in claim 1, wherein obtaining a translation of the text data in the set of map data comprises:
dynamically translating the text data.

14. A method, comprising:
receiving a query, the query indicating that a map is requested;
ascertaining a language in which the map is to be presented, wherein the language in which the map is to be presented is a first language;
obtaining a set of map data for rendering the map, wherein the set of map data includes image data and text data associated with one or more countries, wherein the text data associated with each of the one or more countries is in a language of the corresponding one of the one or more countries;
translating the text data of the set of map data to the first language; and
providing the image data and the translated text data.

15. The method as recited in claim 14, further comprising:
determining whether the first language is different from the language of the countries for which image data is to be presented; and
wherein translating the text data is performed according to whether the first language is different from the language of the countries for which image data is to be presented.

16. An apparatus, comprising:
a processor; and
a memory, at least one of the processor or the memory being adapted for:
receiving a query, the query indicating that a map is requested;
ascertaining a language in which the map is to be presented, wherein the language in which the map is to be presented is a first language;
obtaining a set of map data for rendering the map, wherein the set of map data includes image data and text data, wherein the text data is in a second language;
determining whether the first language is different from the second language; and
translating the text data from the second language to the first language according to whether the first language is different from the second language.

17. The apparatus as recited in claim 16, wherein translating the text data from the second language to the first language according to whether the first language is different from the second language comprises:
translating the text data from the second language to the first language when it is determined that the first language is different from the second language.

18. The apparatus as recited in claim 17, at least one of the processor or the memory being further adapted for:
providing the image data and the translated text data.

19. The apparatus as recited in claim 16, wherein translating the text data from the second language to the first language according to whether the first language is different from the second language comprises:
when it is determined that the first language is not different from the second language, providing the image data and the text data.

20. The apparatus as recited in claim 16, wherein translating the text data from the second language to the first language comprises translating the text data from a first character set to a second character set.
